(19) United States
(12) Patent Application Publication
(10) Pub. No.: US 2008/0279180 A1
(43) Pub. Date: Nov. 13, 2008

(54) Managing a Node that Provides Access to Both Broadband and Narrowband Service

(76) Inventors: Jan Hansen, Holstebro (DE); Henrik Thejl, Struer (DK)

Correspondence Address: ERICSSON INC., 6300 LEGACY DRIVE, M/S EVR 1-C-11, PLANO, TX, 75024, US

(21) Appl. No.: 11/910,705

(22) PCT Filed: Apr. 7, 2005
(86) PCT No.: PCT/SE05/00512

§ 371 Date: Jun. 3, 2008

(51) Int. Cl. H04Q 11/00

(52) U.S. Cl. 370/360

(57) ABSTRACT

The present invention relates to a node, a line board arrangement and a management system in a telephony and data communication systems. The solution is to provide virtual combined ports in a Multi Service Access Node in a flexible way, by combining two standard physical line boards, one broadband line board and one narrowband line board to one virtual line board. The virtual combined port will be one physical access port, providing both narrowband services and DSL broadband services to a customer and subscriber.

### TECHNICAL FIELD

The present invention relates to telephony and data communication systems. More specifically, the present invention relates to a node, a line board arrangement and a management system in a telephony and data communication systems.

### BACKGROUND OF THE INVENTION

Traditionally Network Operators have provided narrowband and DSL broadband access to their customers using two distinct systems—one for narrowband services, e.g. PSTN, POTS, ISDN, etc, and one for broadband services, e.g. DSL, data package communication, IP, etc. As both services need to go on the same copper line (Local Loop), the Network Operator has to cable the traffic for the two systems to the line through a filter, where the filter is capable of splitting the two types of traffic from each other

From a management system point of view this also implies that the Network Operator will have to provision the services to the customer in two different management systems.

FIG. 1 (see drawings) is a block diagram illustrating an overview of a simplified network 10 comprising traditional, parallel access systems, one broadband network 12 for fast data package communication, such as WLAN, Ethernet, internet, etc. and one narrowband network 14 for telephony communication, such as Public Switched Telephone Networks (PSTN), Integrated Services Digital Networks (ISDN), etc.

A subscriber has communication equipment 16, which is capable of transmitting and receiving both narrowband traffic and signals and broadband traffic and signals over a subscriber line 18. The communication equipment 16 may be a telephone, a computer having a modem, a facsimile apparatus, etc, which will transmit and receive voice and data information using any analogue or digital technique and standard. As both narrowband traffic and signals and broadband traffic and signals need to go on the same copper line (Local Loop), the Network Operator has to cable the two systems to the subscriber line through a filter 20. Different subscriber lines are gathered in a main distribution frame 22. As stated before, Network Operators provides narrowband and DSL broadband access to their customers using two distinct systems 12,14—one for narrowband and one for broadband and, therefore, a filter 24 that is capable of splitting the two types of traffic from each other is needed. The Broadband traffic, such as digital data packet traffic, is directed to a DSL node 26, such as a DSL router/data packet switch and further to addresses via the broadband network 28. The narrowband traffic, e.g. POTS and ISDN, is connected to an exchange node 30, which is capable of directing said traffic to the PSTN/ISDN network 32. As illustrated in FIG. 1, the network operator needs two separate management systems 34,36 to handle the two different systems—one for managing and handling the broadband system and the routing/switching nodes containing among other things, the broadband line boards, and one for managing and handling the narrowband system and the switching (exchange) nodes containing among other things, the narrowband line boards. Two different management systems 34, 36 complicate the problem search at traffic disturbance and finding the solution. Furthermore, two different systems and two management systems contains more elements and are therefore more expensive than one single system.

Therefore, Multi Service Access network elements are emerging in the market, combining a number of different access techniques in the same node. Such a Multi Service Access network element may contain a number of different line interfaces for access to different communication networks and systems, such as POTS, ISDN, DSL, Fiber Optic systems, Radio Link systems.

FIG. 2 is a prior art communication network 50 deploying a Multi Service Access network element, but it is similar in many details to the one illustrated in FIG. 1. This allows the Network Operator to use a shared aggregation network for the traffic in both types of service, and to have the provisioning performed from the same management system. The network view becomes more simplified when using a Multi Service Access element, such as a Multi Service Access Nodes (MSAN), but some aspects of providing the services remains.

Even though the MSAN simplifies the handling of combined services, the handling of the traffic splitting filter 24 is still needed, and the provisioning in the management system is still done on two different ports and line boards—one for the narrowband service and one for the broadband service.

### BRIEF DESCRIPTION OF THE INVENTION

The object of the present invention is to solve the above discussed problem when using two different ports and line boards.

The idea is to provide virtual combined ports in a MSAN in a flexible way, by combining two standard physical line boards, one broadband line board and one narrowband line board to one virtual line board. The virtual combined port will be one physical access port, providing both narrowband services and DSL broadband services to a customer and subscriber.

This implies that the Network Operator will have free choice of having either standard narrowband and broadband line boards, or one access point for the customer. The choice will be reflected in the management system, thus allowing the Network Operator to work with either individual narrowband or broadband ports, or work with a single port providing both narrowband and broadband services.

The present invented node is defined according to the mentioned features of independent claim 1.

Different embodiments of the present invented node are described in the dependent claims 2-6.

The present invention also relates to a new line board arrangement defined according to the mentioned features of independent claim 7.

Different embodiments of the present invented arrangement are described in the dependent claims 8-12.

The present invention also relates to a management system defined according to the mentioned features of independent claim 13.

Different embodiments of the present invented management system are described in the dependent claims 14-16.

The present invention providing access to both broadband and narrowband services provides the Network Operator with a number of advantages compared to a standard MSAN solution.

The cabling in the access becomes much simpler. Rather than cabling via a filter to different physical ports, the customer's line is now cabled directly to a single physical port, which can provide all the needed services.

The handling of filters becomes very simple, as there will be no need for filters placed outside/externally the line boards at all. Instead, the filtering is built into the present invention, the Combo Access solution.

Provisioning of services in the management system becomes simple, as there is only one port to be provisioned. Once the port is defined, focus can be directed at the services the customer needs, and these services will be presented in combined views in the management system.

Customer Care situations also becomes simplified, as troubleshooting can be done from a common view in the management system. There is no need to distinguish between narrowband and broadband related problems, as all needed tools can be accessed from the same view. Depending on the tool used, the management system will automatically direct the related commands to the correct location in the MSAN, thereby keeping the impression of a single access point to the Network Operator.

The Network Operator is not locked into a specific configuration of the MSAN, as there is no dedicated “Combo Line Board” or dedicated “Combo Ports” on a line Board, e.g. the 10 first ports are Combo Ports. The standard line boards in the MSAN can be combined to a combo solution, if the Network Operator sees fit. The other way around, a combo solution can easily be returned to a standard line board setup by removing the connecting means. In this the MSAN can be equipped depending on the dynamic environment in the network, like broadband penetration rate.

### BRIEF DESCRIPTION OF THE DRAWINGS

The present invention will in the following be described in more detail with reference to the enclosed drawings, wherein:

FIG. 1 is a block diagram illustrating a simplified network view of traditional, parallel access systems.

FIG. 2 is a block diagram illustrating a prior art communication network deploying a Multi Service Access network element.

FIGS. 3a and 3b are simplified side view illustrations of a broadband line board and a narrowband line board connected over a realisable bridging connector.

In FIG. 3c is schematic illustration showing the two connected boards turned with the connectors directed towards a viewer.

FIG. 4 is a block diagram illustrating a simplified embodiment of the invented node.

FIG. 5 is a block diagram illustrating a simplified access system comprising an embodiment of the invented node.

### DETAILED DESCRIPTION OF THE INVENTION

The present invention will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to these skilled in the art. In the drawings, like numbers refer to like elements.

Throughout this document, the terms broadband and narrowband are used. The term broadband is referring to bit rates equal to or more than 128 Kbytes/s, and the term narrowband is referring to bit rates less than 128 Kbytes/s, in accordance with different telecommunication standards.

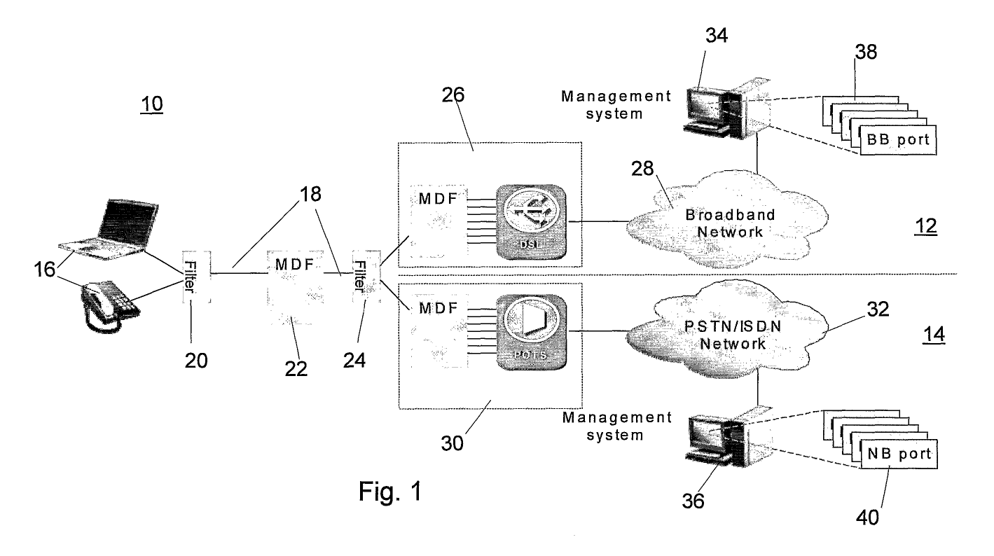

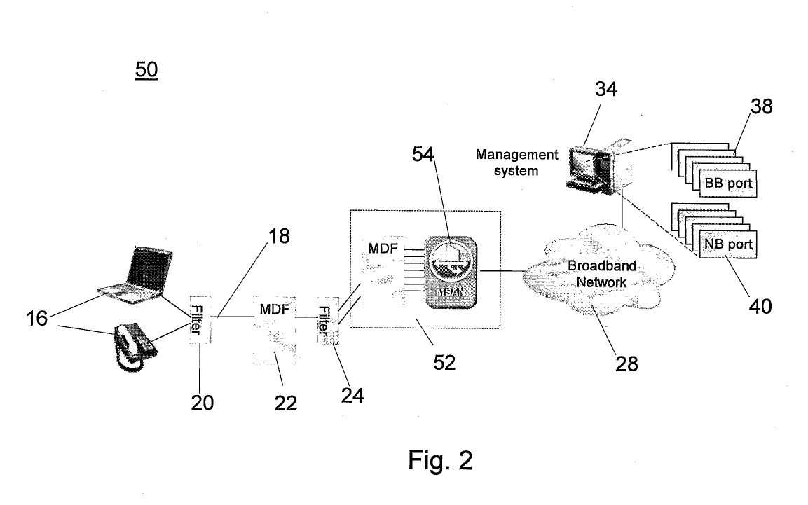

As stated in the description of the background of the invention, FIGS. 1 and 2 illustrates prior art communication networks that are similar in many essential details. However, in the illustrated network 50 in FIG. 2, the exchange node 30 and the DSL node 26 of FIG. 1 are replaced by a common Multi Services Access Node (MSAN) 52. In Multi Services Access Nodes narrowband line boards 40 and broadband line boards 38 are arranged in the same node, preferably in racks. As illustrated in FIG. 2, there is only one management system 34, but this system has to handle two different ports—one for the narrowband service and one for the broadband service. The use of an external traffic splitting filter 24 is therefore still necessary.

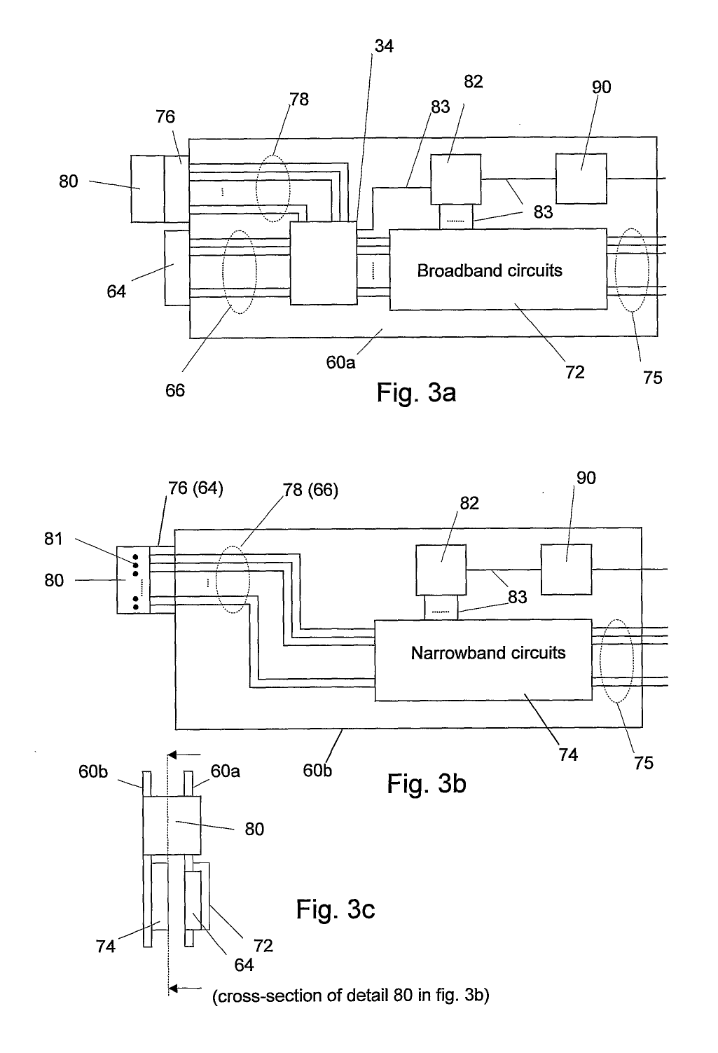

FIGS. 3a and 3b are simplified illustrations of a broadband line board 60a and a narrowband line board 60b according to the invention. The broadband line board 60a, see FIG. 3a, comprises a number of subscriber line connectors, gathered to a common port 64, that are connected via port conductors 66 to a filter device 68 situated after the port of the broadband line board, said filter 68 being capable of directing said broadband traffic/signals further to circuits 72 on the broadband line board 60a and suppressing said narrowband traffic/signals to said circuits on the broadband line board. However, according to the present invention the filter device 68 is capable of directing narrowband traffic/signals, fed on said port 64, further to circuits 74 on the narrowband line board 60b by means of bridging conductors 78 arranged out from the filter device 68 to a contact means 76 for connecting said broadband line board 60a to an adjacent placed narrowband line board 60b. Said means 76 for connecting narrowband line board to said broadband line board, comprising said contact means 76 and said conductors 78 arranged out from the filter device 68, also includes a detachable bridging contact 80, which connects all subscriber lines 18 connected of the broadband line board 60a to all port conductors 66 of the narrowband line board 60b.

On a narrowband line board 60b, FIG. 3b, subscriber line port 64 are arranged. Said port 64 is connected to the narrowband circuits 74 via port conductors. Said port 64 of the narrowband line board 60b is used as contact means 76 for connecting said narrowband line board 60b to an adjacent placed broadband line board 60a. From said contact means bridging conductors 78 are arranged, in the same order as arranged out from the filter device 68 on the broadband board 60a, and attached to said port conductors 66 and therefore subscriber port pair are constituted.

The broadband and narrowband board circuits 72,74 are both connected via conductors 75 (a, b) to other moduls, e.g. switches, sub-switches, routers etc, of the node 62 and MSAN 70.

When the detachable bridging contact/connector 80 is connected to the contact means 76 of the narrowband line board 60b and the contact means 76 of an adjacent placed broadband board 60a, a virtual line board is established. The contact means is therefore a subscriber line port 64 when not connected to the broadband line board, and a contact means 76 in the virtual line board mode.

In FIG. 3b, a cross-section of the bridging connector 80 and the combined connecting means 76,64 and subscriber port is shown. The cross-section is picked in two different levels, for illustrating the conductors in the two connectors—for connector 76 in the board plane and for the bridging connector in a plane between the combined, connected line boards 60a,60b. The cross-sections show that each bridging conductor 78 is connected to a corresponding bridging conductor 81 in the bridging connector 80.

In FIG. 3c, a schematic illustration showing the two connected boards turned with the 80 and 64 directed towards a viewer. The boards are supposed to be inserted in a frame of a rack (not shown).

Each line board 60a, b comprises a line board controller 82 comprising a microprocessor with necessary support circuits for its processing function. Said line board controller 82 is via data busses 83 connected to other circuits, e.g. filter 68, broadband/narrowband board circuits 72/74, transceiver 90 to the management system, etc, mounted on the board for control and management purposes. The line board controller 82 is capable of checking the contact means 76 for connecting said broadband line board to an adjacent placed narrowband line board. If the bridging contact 80 is attached and a virtual line board thereby is established, the line controller is able to automatically detect the bridging contact 80 by using means for bridge detection and generating of a combo_signal.

The bridge detection is preformed e.g. by using resistance measurement by means of already existing line measurement circuits, i.e. measure and detect the difference in resistance between connected and not connected bridging contact 80. The bridge detection may also be performed by testing the possibility to transmit a signal over connecting means 76. Another possibility to detect the bridge connector 80 is by using a separate bridge connector indicating device that will generate different signal responses to the line board controller whether the bridge connector is attached or not. Said means may be implemented as program software instructions that are stored in the line board controller 80 and processed by said microprocessor.

Said means makes it possible for the controller 82 to generate different signals, defined as combo_signals, for informing the management system regarding which mode, combined or separate, the line boards are operating for the moment. Said means is capable of generating a combo_indication_signal, when two line boards are connected/combined to a virtual line board. The combo_indication_signal is transmitted by a transceiver 90 to the management system 34 when said virtual line board 60 has been established.

Said means for bridge detection and generating of a combo_signal may involve bridging contact detection circuits connected to the line board controller on the line board and program software instructions stored in and processed by the line controller.

If the bridging contact 80 is detached from the joined line boards 60a, b, a combo_release_signal is generated by the means for bridge detection and generating of a combo_signal. A combo_release_signal is transmitted by a transceiver 90 to the management system 34 when said virtual line board 60 has been divided into two separate operating standard line boards, i.e. one broadband and one narrowband.

Said means for bridge detection and generating of a combo-signal may also be situated on the narrowband line board.

Both the combo_indication_signal and the combo_release_signal may comprise and carry necessary line board identification data, etc, to make it possible for the management system to identify the line boards in the different virtual line board arrangements.

The management system 34 comprises means for receiving said combo_signal and means for storing information which broadband board and narrowband board that is connected as a pair constituting a virtual line board and which subscriber lines that are connected to said virtual line board. The management system 34 will delete information about a virtual line board from said storing means if a combo_release_signal is received indicating that said earlier joined/combined line boards has been released.

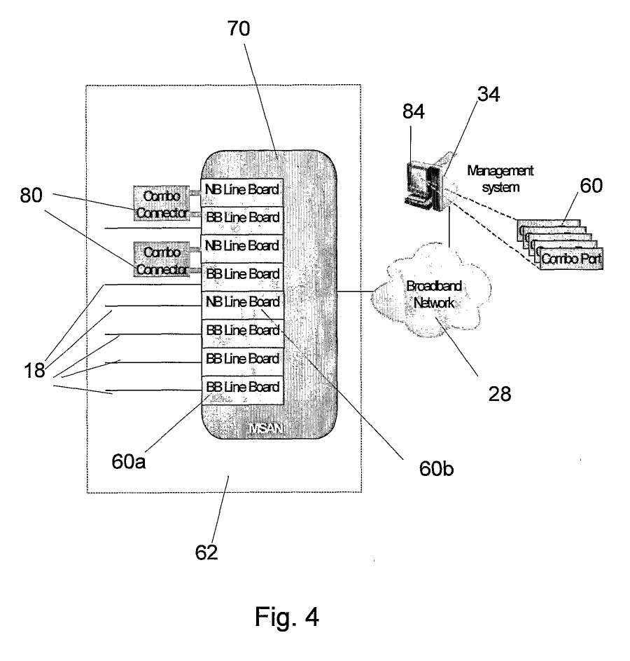

The management system 34 comprises means for presenting on a display screen 84 (see FIG. 4) a common surveillance view/window for virtual line boards providing the combined narrowband and broadband services.

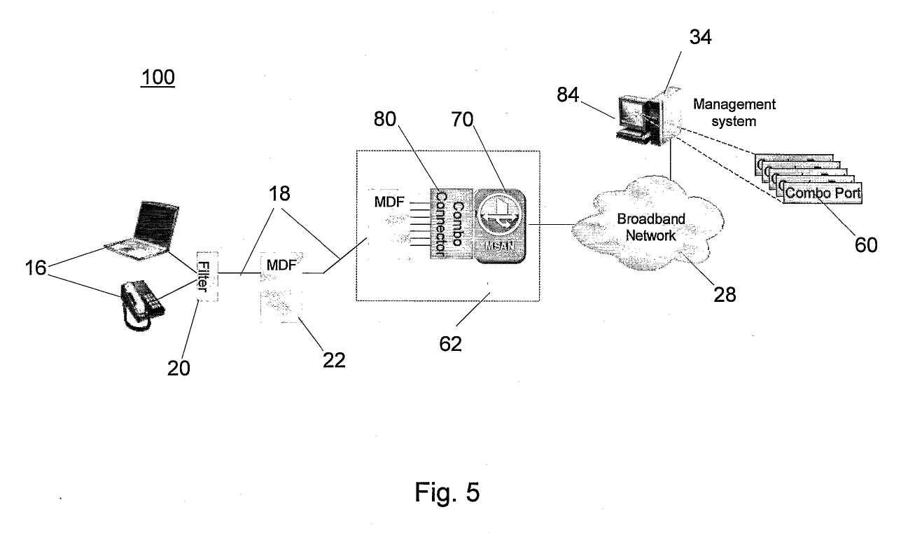

FIG. 4 is a block diagram illustrating a simplified embodiment of the invented node (62, see also FIG. 5). The physical bridging connector 80, even denoted Combo Connector, is used to eliminate the need for the filter (24, see FIGS. 1 and 2), by combining a narrowband port and a broad band port in the MSAN 70 directly. This implies that only one single port of each virtual line board will be visible from the outside the MSAN 70, and this port will be able to provide both narrowband and broad band service. Using the Combo Connector is optional, and the Network Operator can then freely choose between using the standard line boards as it is, or to combine them to a virtual combo line board.

This FIG. 4 illustrates the idea to provide virtual combined ports in a MSAN in a flexible way, by combining two standard physical line boards, one broadband line board 60a, and one narrowband line board 60b to one virtual line board 60. The combined port will be one physical access port, providing both narrowband services and DSL broadband services to a customer and subscriber.

FIG. 4 also emphasises the advantage of the present invention, which implies that the Network Operator will have free choice of having either standard narrowband and broadband line boards, or one access point for the customer. The choice will be reflected in the management system, thus allowing the Network Operator to work with either individual narrowband or broadband ports, or work with a single port providing both narrowband and broadband services.

The Network Operator is not locked into a specific configuration of the MSAN, as there is no dedicated “Combo Line Board” or dedicated “Combo Ports” on a line Board, e.g. the 10 first ports are Combo Ports. The standard line boards in the MSAN can be combined to a combo solution, if the Network Operator sees fit. The other way around, a combo solution can easily be returned to a standard line board setup by removing the connecting means. In this the MSAN can be equipped depending on the dynamic environment in the network, like broadband penetration rate.

FIG. 5 is a simplified block diagram showing an access system comprising an embodiment of the invented node. The management system automatically detects the presence of a Combo Connector in a MSAN, and thereby creates Combo Ports within the management system. This implies that the Network Operator will be able to assign Combo Ports to customers, and provision combined services to this single port. The combined services will be presented to the Network Operator in a single view, where handling of narrowband services and broadband services is done imperceptibly. As indicated in FIG. 5 the actual access now is also simplified compared to the normal MSAN solution. As in FIG. 1, a subscriber's communication equipment 16 will transmit and receive voice and data information using any analogue or digital technique and standard. As both narrowband traffic and signals and broadband traffic and signals need to go on the same copper line (Local Loop), the Network Operator has to cable the two systems to the subscriber line through a filter 20. Different subscriber lines are gathered in a main distribution frame 22. The Network Operator provides narrowband and DSL broadband access to their customers using only systems 100, and the traffic splitting filter 24 is eliminated. Both broadband traffic, such as digital data packet traffic, and the narrowband traffic, e.g. POTS and ISDN, are connected to the same node 62, which is capable of directing said traffic via the broadband network 28. By using the invented combo solution combining narrowband and broadband line boards to one virtual line board, only one separate management system 34 is needed to handle the two different traffic types.

The present invention is not limited to the above-described preferred embodiments. Various alternatives, modifications and equivalents may be used. Therefore, the above embodiments should not be taken as limiting the scope of the invention, which is defined by the appended claims.

1. A node (MSAN) in a telephony and data communication system, said node comprising a narrowband line board providing access to narrowband services and at least one broadband line board providing access to broadband services for at least one subscriber's communication equipment, the communication equipment for transmitting and receiving both narrowband traffic and signals and broadband traffic and signals over a subscriber line, connected to said node (MSAN) said at least one narrowband line board and said at least one broadband line board comprising:
means for connecting said narrowband line board to said broadband line board for providing a virtual line board, and
at least one of said line boards comprises a line board controller for generating a signal and transmitting said signal to a management system for said node.

2. The node (MSAN) according to claim 1, the broadband line board comprising
a filter situated after the port of the broadband line board, said filter for directing said broadband traffic/signals further to circuits on the broadband line board and suppressing said narrowband traffic/signals to said circuits on the broadband line board, and for directing said narrowband traffic/signals further to circuits on the narrowband line board and suppressing said broadband traffic/signals to said circuits on the narrowband line board.

3. The node (MSAN) according to claim 1, the line board controller being situated on the broadband line board, and the signal generated and transmitted being a combo_signal.

4. The node (MSAN) according to claim 1, said means for connecting narrowband line board to said broadband line board for providing a virtual line board including a detachable bridging contact, which connects a contact means of the broadband line board to a subscriber port of the narrowband line board

5. The node (MSAN) according to claim 4, the line controller using program software instructions to detect said bridging contact and generate a combo_indication_signal that is transmitted to the management system when said bridging contact has been attached to a pair of line boards that constitutes a virtual line board.

6. The node (MSAN) according to claim 4, the line controller being able by using adapted program software instructions to detect said bridging contact and generate a combo_release_signal that is transmitted to the management system when said detachable bridging contact has been detached from a pair of line boards that constituted a virtual line board.

7. A line board arrangement in a node of a telephony and data communication system, said line board arrangement comprising
one narrowband line board for providing access to narrowband services and a broadband line board for providing access to broadband services for at least one subscriber's communication equipment which is capable of transmitting and receiving both narrowband traffic and signals and broadband traffic and signals over a subscriber line connected to said node (MSAN) said one narrowband line board and said one broadband line board comprising means for connecting said narrowband line board to said broadband line board for providing a virtual line board, and
at least one of said line boards comprises a line board controller capable of generating a signal and transmitting said signal to a management system for said node.

8. The line board arrangement according to claim 7, the broadband line board comprising
a filter situated after the port of the broadband line board, said filter for directing said broadband traffic/signals further to circuits on the broadband line board and suppressing said narrowband traffic/signals to said circuits on the broadband line board, and,
for directing said narrowband traffic/signals further to circuits on the narrowband line board and suppressing said broadband traffic/signals to said circuits on the narrowband line board.

9. The line board arrangement according to claim 7 said line board controller being situated on the broadband line board and the signal generated and transmitted is a combo_signal.

10. The line board arrangement according to claim 7, said means for connecting said narrowband line board to said broadband line board for providing a virtual line board including a detachable bridging contact, which connects a contact means of the broadband line board to a subscriber port of the narrowband line board.

11. The line board arrangement according to claim 10, the line controller being able by using adapted program software instructions to detect said bridging contact and generate a combo_indication_signal that is transmitted to the management system when said bridging contact has been attached to a pair of line boards that constitutes a virtual line board.

12. The line board arrangement according to claim 10, the line controller being able by using adapted program software instructions to detect said bridging contact and generate a combo_release_signal that is transmitted to the management system when said detachable bridging contact has been detached from a pair of line boards that constituted a virtual line board.

13. The management system for managing at least one node according to claim 1, the system comprising
means for receiving a combo_signal and
means for storing information regarding which broadband line board and narrowband line board that are connected as a pair constituting a virtual line board.

14. The management system according to claim 13, said system comprising
means for presenting on a display screen a common surveillance view/window for virtual line boards providing the combined narrowband and broadband services.

15. The management system according to claim 13, wherein a received signal is a combo_indication_signal.

16. The management system according to claim 13, the means for receiving a combo_signal being adapted for deleting information about a virtual line board from said storing means if the combo_signal is a combo_release_signal, which is received indicating that said earlier joined/combined line boards has been released.
